(19) United States
(12) Patent Application Publication
(10) Pub. No.: US 2004/0035300 A1
(43) Pub. Date: Feb. 26, 2004

(54) Apparatus for removing a baked article from a mold

(76) Inventor: Lawrence S. Maccherone, Towson, MD (US)

Correspondence Address: JONES DAY, 77 WEST WACKER, CHICAGO, IL, 60601-1692, US

(21) Appl. No.: 10/606,656

(22) Filed: Jun. 26, 2003

Related U.S. Application Data
(60) Provisional application No. 60/392,138, filed on Jun. 27, 2002.

(51) Int. Cl. A23L 1/00

(52) U.S. Cl. 99/353

(57) ABSTRACT

An apparatus for baking an article in a mold comprises retractable mold portions that define a mold cavity, at least one mold portion having associated therewith a mold stripper, the mold stripper fitting within the mold portion and being capable of remaining in contact with the baked article while the mold portion is retracted, to facilitate release of said baked article from said mold portion.

This application claims the benefit under 35 U.S.C. § 119(e) of provisional application Serial No. 60/382,138, filed Jun. 27, 2002.

### BACKGROUND OF THE INVENTION

This invention relates to an apparatus for removing a baked article from a mold. More particularly, this invention relates to an apparatus for removing a baked article from a mold in a baking operation in which some adherence of the article to the mold is desirable to produce a satisfactory baked article.

The art of baking articles from a liquid batter in a mold is very old. In the food industry, such articles can include waffles and ice cream cones. It is well-known in the art of baking such articles from a liquid batter that good surface characteristics of the article are most often obtained when the batter has at least some adherence to the surfaces of the mold during the baking process. Such surface adherence results in a smooth, even “skin” on the surface of the finished product. It is further known in the art that steam or other gases that volatilize from the batter during the baking process can collect between the article being baked and the surface of the baking mold. The steam and other gases can impede the adherence between the baked article and the mold surface, resulting in a baked article with uneven surface texture, or even holes or gaps in the article. In the art of baking, the ingredients and their proportions in the batter must be carefully controlled along with the baking conditions to achieve a baked article that is baked through thoroughly and has an acceptable surface texture.

While good adherence to the mold surface during the baking process is desirable from the standpoint of obtaining an article with desired surface characteristics, it can present difficulty in releasing the baked article from the mold. Prior art attempts to deal with the problem of release from the mold have involved the use of non-stick materials on the mold surfaces, and the use of release agents in the batter, such as fats or oils. When such non-stick materials or release agents are used, poor surface formation of the finished baked article can occur, as described above. The process designer must carefully consider the batter ingredients, the baking conditions, and the use of release agents to strike a delicate balance between the goals of mold adherence during baking and mold release after baking.

Certain baked rigid articles can be removed from a mold by mechanical means. For example, an ice cream cone is baked in a two part mold comprising a female portion and a male portion that fits therein with a space in between to accommodate the baked cone. When the baking cycle is complete, the male mold is removed partially while rings on the female mold extending radially inwardly engage the top rim of the cone to retain the cone in the female portion. The female portion is a two-part mold which parts are then separated to release the baked cone completely.

In a commercial baking operation in which baking in molds is done in an assembly line, the problem of release of an article form a mold is critical. If the process designer errs on the side of too little adherence to the mold, then a greater proportion of the baked articles will be deemed unacceptable, but these unacceptable articles will not require that the production line be shut down. If, however, the process designer errs on the side of too much adherence to the mold, then a greater number of baked articles will be acceptable, but if any articles cannot be released from the mold, then the entire production line must be shut down to remove the stuck article, clean the mold, and bring the operation back on line. Because it is highly undesirable for a commercial production line to be shut down for any length of time, most process designers for baking lines err on the side of too little adherence of the article to the mold during baking. This approach can lead to a product rejection rate on the order of 15% or higher.

In recent years, the use of commercial baking processes has expanded beyond the realm of food products to encompass food packaging articles, and in particular biodegradable food packaging articles. Such articles are baked from a liquid composition comprising water, limestone, food starch, and other common ingredients. One such group of products is sold by Earth Shell Corporation having headquarters in Santa Barbara, Calif. under the trademark EARTHSHELL. Information about this line of products can be found at www.earthshell.com. Such products can include, for example, disposable biodegradable plates, cups, and hinged lidded boxes such as are used in fast-food restaurants to package sandwiches and the like. Such products are typically manufactured by placing a portion of the liquid composition in the bottom of a two-part mold, closing the top part of the mold over the bottom part so that the liquid composition spreads evenly between the two parts, heating the mold so that the liquid composition bakes into a solid baked article, opening the mold, and removing the article. The process designer must carefully control the ingredients of the liquid composition, the proportions of those ingredients, the type of mold surfaces used, the use of release agents, if any, and the baking parameters to achieve a balance between acceptable adherence during baking and acceptable release after baking. Further, the shape of the top part of the mold complements the shape of the bottom part of the mold such that the space between the molds defines the shape of the desired finished product. Thus certain products will require more complex mold surfaces than others, making the problem of release of the article form the mold even more difficult.

It is thus one object of the invention to provide an apparatus for removing a baked article from a mold.

It is another object of the invention to provide an apparatus for removing a baked article from a mold wherein adherence of the article to the mold during baking is desirable to provide a baked article having a satisfactory surface appearance.

### SUMMARY OF THE INVENTION

These and other objects of the invention are met by the apparatus of the instant invention in which a two part mold for a baked article is provided with means for mechanically stripping the baked article from the mold after baking is complete. The apparatus comprises one or more strippers removably fitted within cavities in the mold surfaces, the strippers having baking surfaces flush and contiguous with the mold surfaces, such that during the baking operation the stripper baking surface functions as part of the mold. The strippers and the mold surfaces are independently retractable. In a preferred embodiment of the invention, first and second strippers are fitted into each of the two halves of a baking mold. When the baking cycle is complete, a first of the mold halves retracts from the baked article while the first and second strippers remain engaged with the baked article, thus facilitating mechanical stripping of the baked article from the surface of the first half of the mold. The second of the mold halves then retracts from the baked article while the first and second strippers remain engaged with the baked article. The first stripper is removed from the baked article, and the article is removed from the second stripper.

It may be seen that the inventive apparatus allows the baking process and the release process to be designed as two separate processes. The baking process, including the ingredients of the composition and their proportions, the baking surfaces, and the baking parameters of time and temperature, can all be chosen to provide optimum adherence of the baked article to the mold surfaces. This ensures that a higher proportion of satisfactory baked articles will be produced. At the same time, the stripping apparatus facilitates removal of the product from the mold, so that it is far less likely that a line would have to be shut down because of failure to remove a finished baked article from a mold.

### DESCRIPTION OF THE FIGURES

FIG. 1 is a cross-sectional view of a preferred embodiment of an apparatus of the instant invention, shown prior to the beginning of a baking cycle.

FIG. 2 illustrates the apparatus of FIG. 1 showing the baking mold fully closed as during the baking cycle.

FIG. 3 illustrates the apparatus of FIG. 1 after the baking cycle, in which the first half of the mold is in a partially retracted position.

FIG. 4 illustrates the apparatus of FIG. 1 after the baking cycle, in which the strippers associated with the second half of the mold are in the extended position.

FIG. 5 illustrates the apparatus of FIG. 1 after the baking cycle, in which the first part of the mold along with its associated strippers is in the fully retracted position.

### DETAILED DESCRIPTION OF THE INVENTION

The following detailed description of a preferred embodiment of the invention illustrates an embodiment wherein the invention is used with a two-part closed mold for baking a biodegradable, hinged, lidded sandwich container such as are used in fast food restaurants. It will be understood that the instant invention is not so limited, and that the teachings herein can be applied to any apparatus or method wherein an article is baked in a mold.

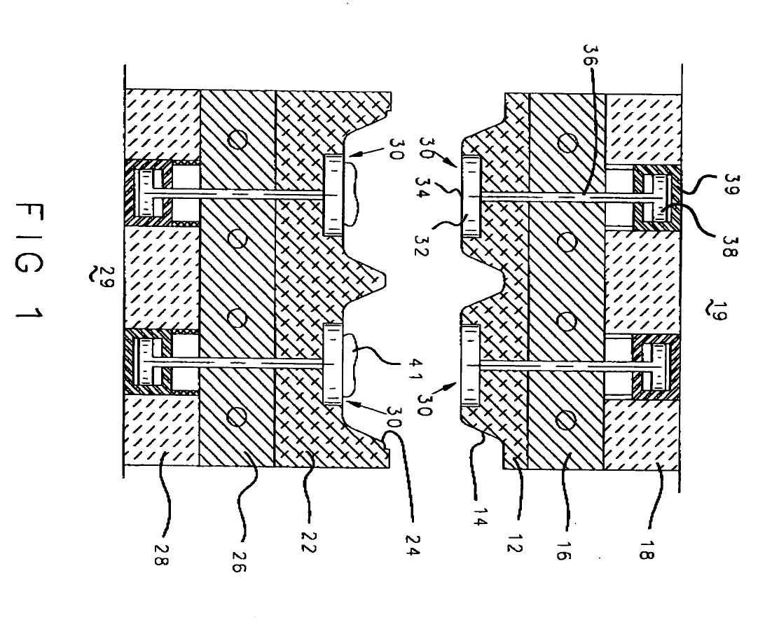

FIG. 1 illustrates a closable two-part mold used to form a disposable biodegradable sandwich container. The mold comprises first mold part 12 with baking surface 14, and second mold part 22 with baking surface 24. It may be seen that baking surface 14 and baking surface 24 are configured in complementary fashion such that when the mold is closed the baking surfaces 14 and 24 define therebetween a cavity of the size and shape of the desired molded product. Each of mold parts 12 and 22 is provided on the surface opposite baking surfaces 14 and 24 with a heater platen 16, 26, respectively. Each heater platen 16, 26 is provided with a layer of insulation 18, 28 as shown. In the region 19 above insulation layer 18 is an upper press ram, not shown, that functions to move first mold part 14, heater platen 16, and insulation layer 18 downwardly toward second mold part 22. In the region 29 below insulation layer 28 is a lower press platen, not shown.

In the illustrated embodiment, each of the mold parts 12, 22 is provided with two strippers 30 for a total of four strippers. It will be appreciated by those skilled in the art that more or fewer strippers could be used, depending on the configuration of the mold and the properties of the desired article. Only one of the strippers 30 is described in detail below, it being understood that the same description is equally applicable to all the strippers.

As illustrated in FIG. 1, stripper 30 comprises a press plate 32 having a baking surface 34. Press plate 32 and baking surface 34 are sized and dimensioned to fit within a corresponding cavity in first mold part 12, such that baking surface 34 is flush and contiguous with first mold part baking surface 14. Press plate 32 is operatively connected to rod 36, which extends through first mold part 12, heater platen 16, and insulation layer 18 to stripper operation means 38. Stripper operation means 38 can function mechanically, electrically, hydraulically, or pneumatically, depending on the design requirements of a particular application. Stripper operation means 38 is housed within a piston 39 disposed within insulation layer 18.

In FIG. 1, the apparatus of the instant invention is shown prior to the beginning of a baking cycle. A quantity of the baking composition 41 is placed within second mold part 22, in an amount and location such that it will flow evenly in the volume between first mold part 12 and second mold part 22 when the mold is closed. As shown in FIG. 1, in the illustrated embodiment quantities of the composition are placed on the surfaces 34 of each of the stripper press plates 32 of second mold part 22.

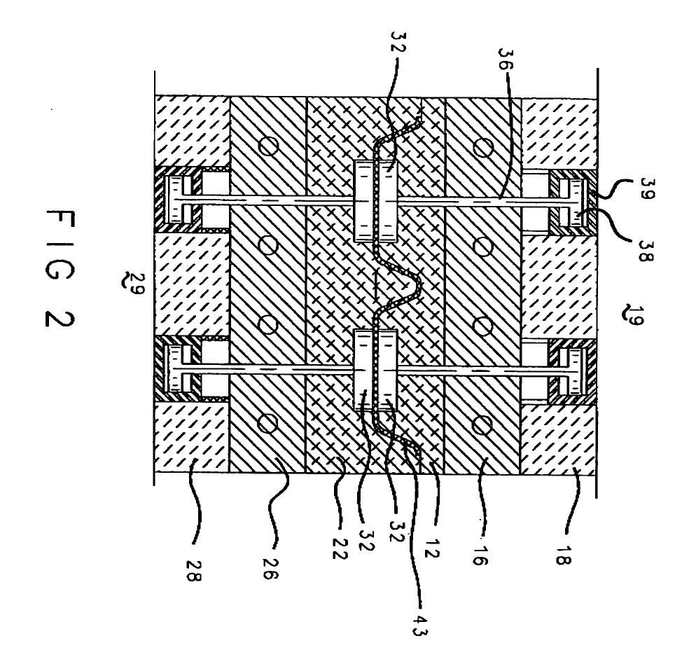

FIG. 2 illustrates the apparatus of FIG. 1 showing the baking mold fully closed as during the baking cycle. It may be seen that surfaces 14 and 24 of first and second mold parts 12 and 22, together with the baking surfaces of the 34 the various press plates 32 define a cavity in the shape of the desired baked article. The composition 41 spreads evenly within the cavity and bakes into solid baked article 43, in this case a disposable sandwich packaging unit. During the baking cycle, the baked article 43 will have a desired adherence to the surface 14 and 24 of mold parts 12 and 22.

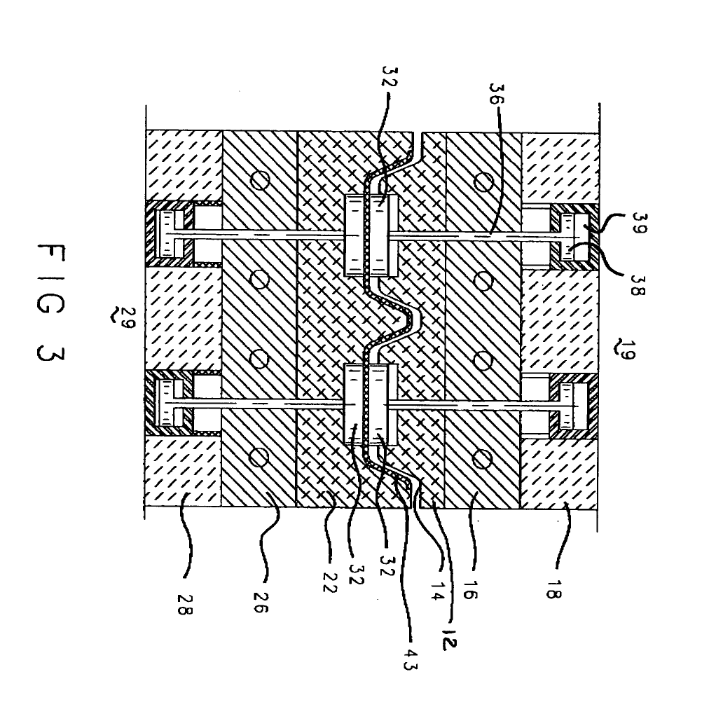

FIG. 3 illustrates the apparatus of FIG. 1 after the baking cycle, in which the first half of the mold is in a partially retracted position such that baking surface 14 of first mold part 12 is no longer in contact with baked article 43. Stripper operating means 38 have moved downwardly within pistons 39 by a dimension about equal to the distance that surface 14 has moved away from baked article 43, such that baking surfaces 34 of pressure plates 32 remain in contact with baked article 43. The pressure exerted by pressure plates 32 against baked article while first mold part 12 is moved into the partially retracted position facilitates the mechanical stripping of baked article 43 from surface 14 of first mold part 12.

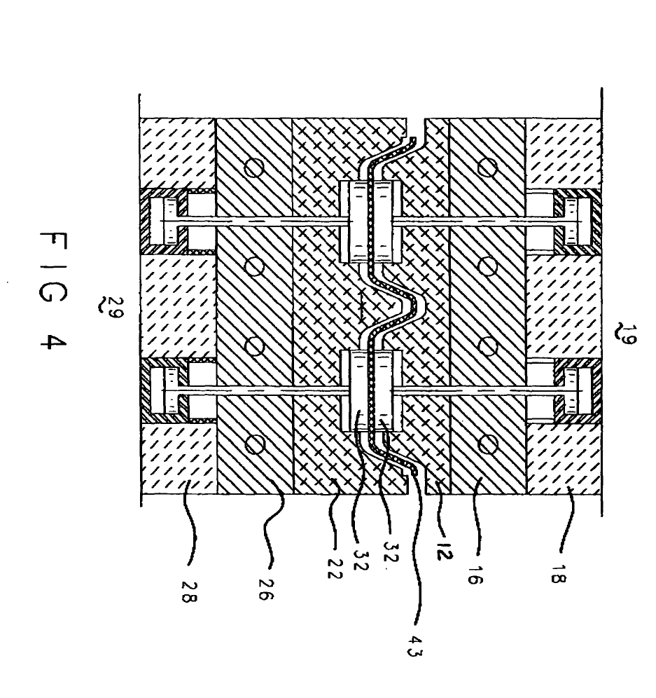

FIG. 4 illustrates the apparatus of FIG. 1 after the baking cycle, in which the strippers 30 associated with the second mold part 22 are in the extended position. Stripper operating means 38 have moved upwardly within pistons 39 by a dimension about equal to the distance that surface 14 has moved away from baked article 43, such that baking surfaces 34 of pressure plates 32 remain in contact with baked article 43. The pressure exerted by pressure plates 32 against baked article while strippers 30 are moved into the partially extended position facilitates the mechanical stripping of baked article 43 from surface 24 of second mold part 22.

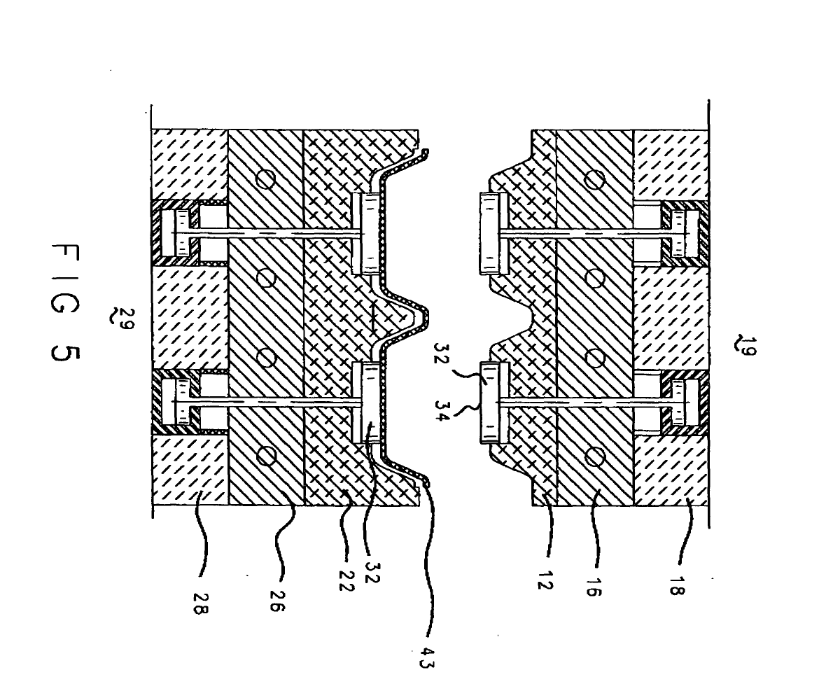

FIG. 5 illustrates the apparatus of FIG. 1 after the baking cycle, in which first mold part 12 along with its associated strippers 30 is in the fully retracted position. It can be seen that the baking surfaces 34 of the pressure plates 32 of the strippers 30 associated with first mold part 12 are no longer in contact with baked article 43. Baked article 43 can now be lifted out of the mold.

The apparatus of the instant invention provides a means for mechanically stripping a baked article from a mold after baking is complete. Although release agents can be used, the mechanical strippers of the instant invention operate substantially independently of the surface release properties of either the mold or the baked article. This allows the process designer substantially greater latitude in selecting the ingredients and their proportions in the composition to be baked, and in selecting the baking process parameters. A higher percentage of baked article with acceptable surface characteristics can be achieved, while greatly reducing the incidence of release failures which would require shutting down a production line.

While the instant invention has been described in terms of a presently preferred embodiment, other embodiments and modifications will be apparent to those of skill in the art upon reading the above disclosure and review of the accompanying drawings. It will be understood for example, that the number and placement of the strippers can be varied according to the size and shape of the mold and the baked article. Such other embodiments and modifications and other equivalents are intended to be within the scope of the instant invention.

What is claimed is:

1. An apparatus for baking an article, the apparatus comprising
a mold comprising mold portions, each mold portion having a baking surface, said mold portions fitting together such that said baking surfaces define a mold cavity,
at least one mold portion having a cavity and having associated therewith a mold stripper, said mold stripper comprising a press plate having a baking surface, said press plate being sized and dimensioned to fit within said mold portion cavity such that said press plate baking surface is flush and contiguous with said associated mold portion baking surface,
said mold portions and said mold stripper being independently movable, whereby said mold portions and mold stripper can be moved together to define a mold cavity in which an article can be baked, and whereby after baking said mold portions can be moved away from the baked article while said baking surface of said mold stripper press plate remains in contact with the baked article to facilitate separation of said associated mold portion baking surface from the baked article.

2. The apparatus of claim 1 wherein each mold portion has a cavity therein and a mold stripper associated therewith.

3. The apparatus of claim 1 wherein said mold stripper further comprises stripper operation means for moving said mold stripper as desired for baking and releasing the baked article.

4. The apparatus of claim 1 wherein said mold cavity is configured for baking a food service article.
